(19) United States
(12) Patent Application Publication
(10) Pub. No.: US 2010/0093196 A1
(43) Pub. Date: Apr. 15, 2010

(54) SOCKET CONNECTOR HAVING CONTACTS ARRANGED BETWEEN STANDOFFS

(75) Inventors: SHUO-HSIU HSU, Tu-Cheng (TW); HAO-YUN MA, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/578,528

(22) Filed: Oct. 13, 2009

(30) Foreign Application Priority Data
Oct. 14, 2008 (TW) 97218287

(51) Int. Cl. H01R 12/00

(52) U.S. Cl. 439/80

(57) ABSTRACT

An electrical connector assembly (100) comprises an electrical connector for electrically connecting an electronic package with a circuit substrate 6 and comprises a load plate (1) for pressing the electronic package, a locking device (2) assembled to the load plate (1) and comprises a fastener (22) assembled to the load plate (1) and a lever (21), the fastener (22) is urged to rotate to lock or open the load plate (1) by the lever (21) when the lever (21) is rotated.

### BACKGROUND OF THE INVENTION

1. Field of the Invention

The present invention relates to an electrical connector, and more particularly, to an electrical connector having seating members arranged between contacts thereof for testing the positions of the contacts.

2. Description of the Prior Art

Taiwanese Utility Model Patent No. M244598 issued to Lu on Sep. 21, 2004 discloses a conventional electrical connector for electrically connecting a module with a PCB. The electrical connector comprises a socket body having a number of terminals received therein and a metallic cover assembled to the socket body. The socket body comprises a base and two sidewalls extending upwardly from the base. The base and the sidewalls form a space for disposing a module therein. The base defines a plurality of passageways for receiving the terminals therein. The terminal comprises a contacting portion extending into the space for electrically connecting with the module. The cover defines a slot and the side surface of the side wall defines a pinshaft received in the slot and can move into the slot.

When the insulative housing is formed through the molding process, the base of the insulative housing forms a large surface which is easy deformed during molding. Generally, the base serves as a datum for testing the positions of the contacts. Therefore, it is difficult to test true position of the contacting portion of the terminals due to deformation of the base. Accordingly, manufacture precision of the electrical connector is increased.

In view of the above, a new electrical connector assembly that overcomes the above-mentioned disadvantages is desired.

### SUMMARY OF THE INVENTION

Accordingly, an object of the present invention is to provide an electrical connector having seating members arranged between contacts thereof for testing true position of the contacting portions of the contacts.

To fulfill the above-mentioned object, an electrical connector comprises an insulative housing, a plurality of contacts and a cover, the insulative housing comprises a plurality of sidewalls extending upwardly from the base, the base and the sidewalls together form a receiving space, the base defines a plurality of passageways and a seating member located between every two passageways, the contacts are received in the passageways and each defines a contacting portion extending into the receiving space, the contacting portion extends beyond the upper surface of the seating members, the cover is pivotally assembled on two opposite sidewalls of the insulative housing and is located between a closed position, in which the receiving space is closed and an opened position, in which the receiving space is accessible.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an electrical connector in accordance with a preferred embodiment of the present invention;

FIG. 2 is an isometric view of the insulative housing of the electrical connector with the contacts received therein;

FIG. 3 is a cross-sectional view of FIG. 2 taken along the line 3-3, showing the contacting portion of the contacts locates beyond the upper surface of the seating member;

FIG. 4 is an assembled view of FIG. 1, showing the load plate at an opened position;

FIG. 5 is similar to FIG. 4, showing the load plate is positioned on the insulative housing substantially; and

FIG. 6 is similar to FIG. 4, showing the load plate in a closed position.

### DETAILED DESCRIPTION OF THE PREFERRED EMBODIMENT OF THE INVENTION

Reference will now be made to the drawings to describe the present invention in detail.

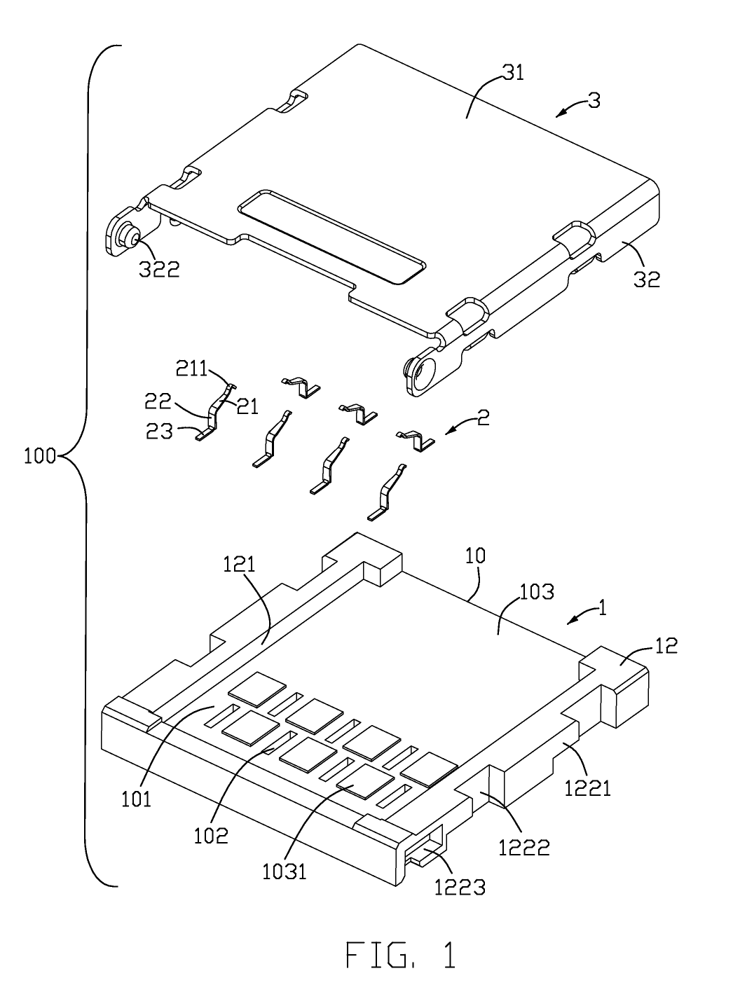

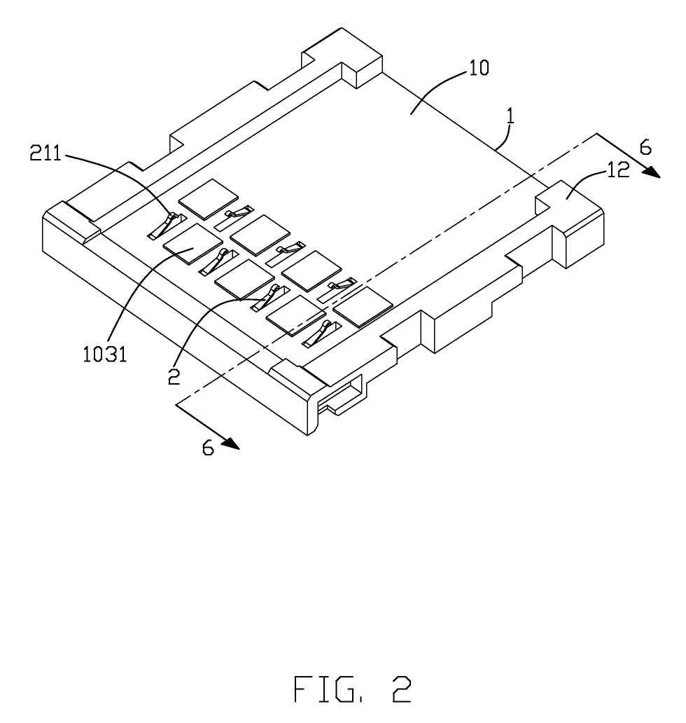

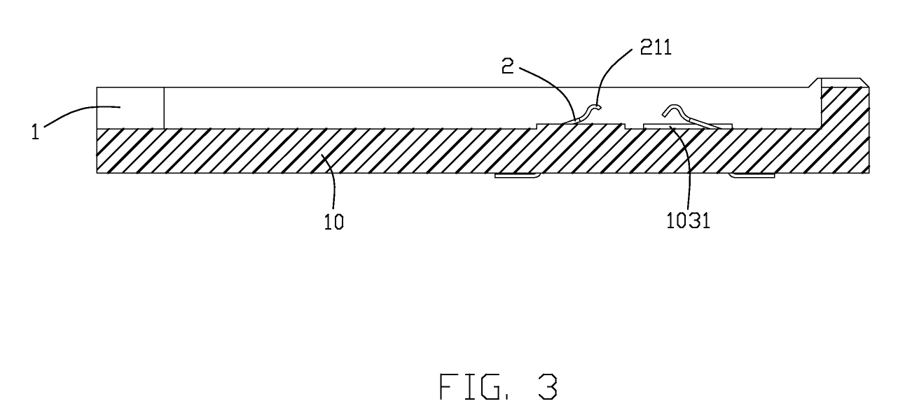

Referring to FIGS. 1-4, an electrical connector 100 in accordance with the present invention is used to convert electric and optical signal from a module (not shown) to a circuit substrate (not shown). The electrical connector 100 comprises an insulative housing 1, a plurality of contacts 2 received in the insulative housing 1 and a cover 3 assembled on the insulative housing 1.

The insulative housing 1 is configured to a rectangular shape and comprises a base 10, four sidewalls 12 extending upwardly from the base 10. The base 10 and the four sidewalls 12 together formed a receiving space 101. The base 10 defines a plurality of passageways 102 arranged in a first row and a second row. The base 12 also defines a plurality of seating members 1031 adjacent the passageways 102. The seating member 1031 is arranged between two adjacent passageways 102 in the first row and the second row, and the seating member 1031 in the first row or the second row is corresponding to the passageway 102 in the second row or the first row. One of the sidewalls 12 defines an opening 15 communicating with the receiving space 101. Two of the sidewalls 12 are opposite to each other and each defines a groove 1223 at one end, a recess 1222 at the other end and a lock portion 1221 near the recess 1222.

The contacts 2 are positioned in the passageways 102 and each comprises a base portion 22, a soldering portion 23 extending from one end of the base portion 22 and a spring arm 21 extending from the other end of the base portion 22. The spring arm 21 defines a contacting portion 211 extending into the receiving space and the contacting portion 211 is located beyond the upper surface of the seating member 1031. The contacts 2 in the first and second rows are opposite to each other.

The cover 3 is made of sheet metal and comprises a flat body plate 31 and two flanges 32 extending downwardly from the body plate 31. The flange 32 defines a column-shaped pinshaft 322 corresponding to the groove 1223 and also defines a stop portion 321 corresponding to the lock portion 1221. The stop portion 321 comprises a connecting portion 3210 extending downwardly from the flange 32 and an interlock portion 3211 extending curvedly from the connecting portion 3210. The interlock portion 3211 defines a guiding portion 3212 at an end thereof

When the electrical connector 100 is assembled, the contacts 2 are assembled in the passageways 102 and the cover 3 is assembled on the insulative housing 1. The pinshaft 34 is located in the groove 1223, so that the cover 3 can move from an opened position to a closed position.

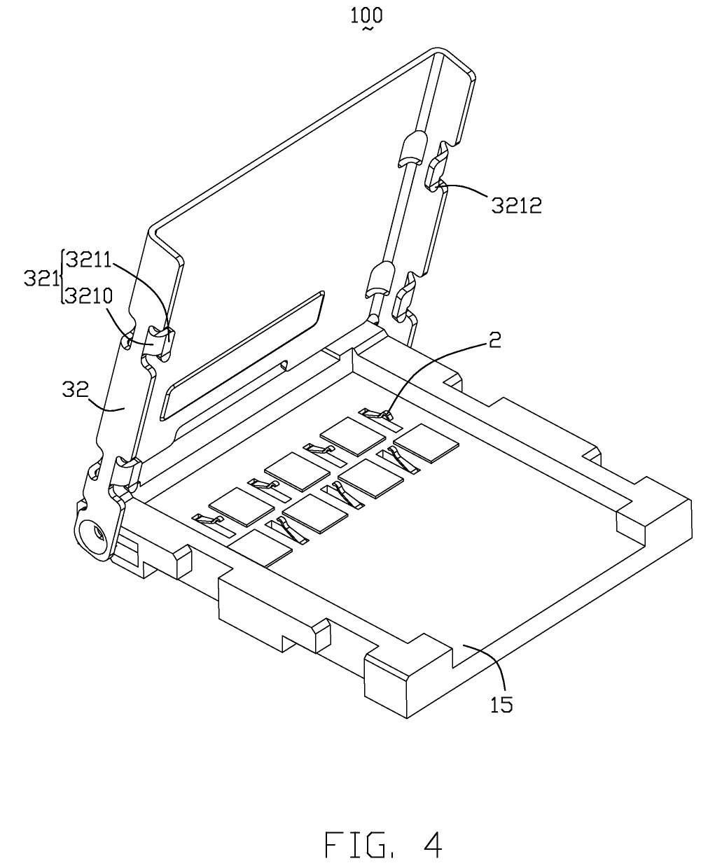

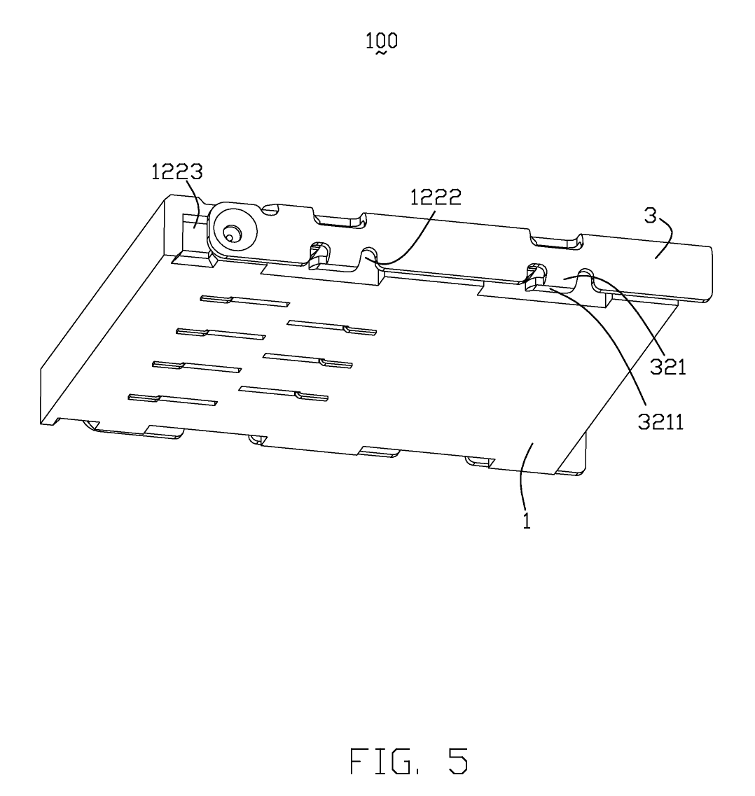

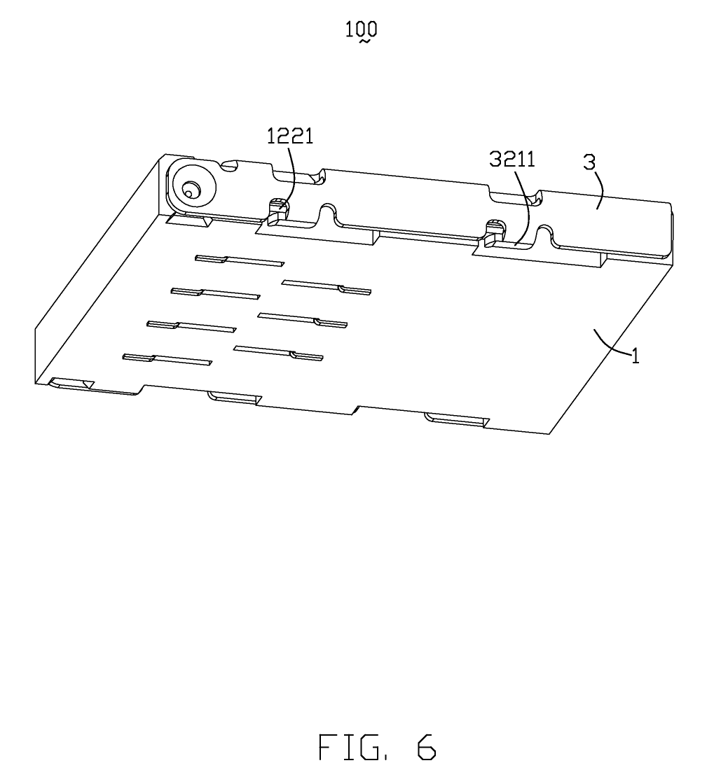

Referring to FIGS. 4-6, showing the operation of the electrical connector 100. First, the cover 3 is opened so that the module can be disposed in the receiving space 101. Then, the cover 3 covers the insulative housing 1 substantially. In this position, the stop portion 321 is located in the recess 1222. Then the cover 3 is further pushed to make it to move forwardly and the pinshaft 34 is also moved into the groove 1223 until the stop portion 321 is moved to the underside of the lock portion 1221 to interlock with the lock portion 1221. In this position, the cover 3 is locked on the insulative housing 1. In this process, the guiding portion 3212 can make the stop portion 321 to move to the underside of the lock portion 1221 easily.

The insulative housing 1 is provided with a plurality of seating members 1031 on the base 12 thereof Therefore, it is the seating members 1031 not the base 12 servers as a datum for testing the contacts 2. Since the seating member 1031 has a smaller area than the base 12, deformation during molding will not affect the seating member 1031 as the base 12. Therefore, the seating member 1031 can be a more acurate datum than the base 12. Accordingly, it is easily and reliably to control the positions of the contacts 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing comprising a base and a plurality of sidewalls extending upwardly from the base, the base and the sidewalls together forming a receiving space, the base defining a plurality of passageways and a seating member located between two passageways;
a plurality of contacts received in the passageways and each defining a contacting portion extending into the receiving space, the contacting portion extending beyond an upper surface of the seating member; and
a cover being pivotally assembled on two opposite sidewalls of the insulative housing and located between a closed position, in which the receiving space is closed and an open position, in which the receiving space is accessible.

2. The electrical connector as claimed in claim 1, wherein the passageways are arranged in a first row and a second row.

3. The electrical connector as claimed in claim 2, wherein at least one seating member is arranged between two adjacent passageways of the first row.

4. The electrical connector as claimed in claim 2, wherein the seating member in the first row is corresponding to the passageway in the second row.

5. The electrical connector as claimed in claim 2, wherein the contacts arranged in the first and second rows are opposite to each other.

6. The electrical connector as claimed in claim 1, wherein one sidewall defines an opening communicating with the receiving space.

7. The electrical connector as claimed in claim 1, wherein the cover comprises a body plate and a pair of flanges extending downwardly from the body plate.

8. The electrical connector as claimed in claim 7, wherein the opposite sidewalls each define a groove and the flanges each define a pinshaft positioned in the groove and movable in the groove to move the cover in the horizontal direction.

9. The electrical connector as claimed in claim 7, wherein each of the two opposite sidewalls defines a locking portion and the flanges each define a stop portion interlocked with the locking portion.

10. A socket connector, comprising:
an insulative housing defining a base with peripheral sidewalls jointly defining a receiving space therebetween, the base defining a plurality of passageways and a plurality of seating members extending upwardly therefrom;
a plurality of contacts assembled within the passageways and having a contact engaging portion extending beyond the upper surface of the seating member; and
a metallic cover being pivotally and moveably assembled onto two opposite sidewalls and located between a closed position in which the receiving space is completely closed and an opening position, in which the receiving space is accessible.

11. The electrical connector as claimed in claim 10, wherein the passageways are arranged in a first row and a second row.

12. The electrical connector as claimed in claim 11, wherein at least one seating member is arranged between two adjacent passageways of the first row.

13. The electrical connector as claimed in claim 12, wherein the opposite sidewalls each defines a locking portion and the flanges each defines a stop portion interlocked with the locking portion.

14. The electrical connector as claimed in claim 10, wherein the cover comprises a body plate and a pair of flanges extending downwardly from the body plate.

15. The electrical connector as claimed in claim 14, wherein the cover can move back and forth along the housing by a pinshaft and groove arrangement between the cover and the housing.
